(19) United States
(12) Patent Application Publication
(10) Pub. No.: US 2026/0138517 A1
(43) Pub. Date: May 21, 2026

(54) ROLLOUT SUPPORTED TABLE FOR VEHICLE CABIN

(71) Applicant: Ford Global Technologies, LLC, Dearborn, MI (US)

(72) Inventors: Vishal Vinayak Nageshkar, Windsor (CA); John Wayne Jaranson, Dearborn, MI (US)

(73) Assignee: Ford Global Technologies, LLC, Dearborn, MI (US)

(21) Appl. No.: 18/948,978

(22) Filed: Nov. 15, 2024

(51) Int. Cl. B60N 3/00

(52) U.S. Cl. CPC B60N 3/001

(57) ABSTRACT

A rollout table assembly having a housing secured to a vehicle, the housing having an opening and a rollout table coupled to the housing. The rollout table is operable between an extended position and a retracted position along a deployment axis, the rollout table having a plurality of slats running perpendicular to the deployment axis. The rollout table assembly also has a support mechanism having a first arm with a first end and a second end, where the first end is coupled to the rollout table and the second end is coupled to the housing. The rollout table is rolled up within the housing in the retracted position, and the rollout table is at least partially extended from the opening of the housing in the extended position.

### FIELD OF THE DISCLOSURE

The present disclosure generally relates to a stowable table for a vehicle.

### BACKGROUND OF THE DISCLOSURE

Consumers of vehicles may use a vehicle in a variety of ways, such as for work, tailgating, storage, and leisure. Some vehicles offer consumers options for tables and trays to set items on and/or to use as a work surface, particularly when the vehicle is stopped and inoperable. However, the space interior to and proximate vehicles is limited, creating design constraints and making it desirable to streamline the features therein. Consumers of vehicles may desire a stowable table to increase utility and/or space provided by the vehicle. There is therefore a need for additional enhancements in the characteristics of stowable tables for vehicles.

### SUMMARY OF THE DISCLOSURE

According to a first aspect of the present disclosure, a vehicular table assembly has a housing secured to a vehicle, where the housing has an opening. A rollout table is coupled to the housing and operable between an extended position and a retracted position along a deployment axis, and the rollout table has a plurality of slats running perpendicular to the deployment axis. The vehicular table assembly also has a support mechanism having a first arm with a first end and a second end, where the first end is coupled to the rollout table and the second end is coupled to the housing. In the retracted position, the rollout table is rolled up within the housing. In the extended position, the rollout table is at least partially extended from the opening of the housing.

Embodiments of the first aspect of the present disclosure can include any one or a combination of the following features:
the first arm has one pinned end and one unpinned end;
a reel is disposed in an interior space defined by the housing, the reel being rotatably coupled to the housing;
the rollout table has a free end and an opposing secured end coupled to the reel within the housing, a crossbar is disposed along the free end of the rollout table, and the first end of the first arm is coupled to the crossbar;
a second arm pivotably coupled to the first arm, thereby forming a scissor joint, wherein the first end of the first arm and a first end of the second arm are connected to the crossbar, and the second end of the first arm and a second end of the second arm are coupled to the housing;
one end of each of the first and second arms forms a pin joint connection with one of the housing and the crossbar, and one end of each of the first and second arms is slidably disposed within a slot defined by one of the housing and the crossbar;
the slot includes one or more lock-and-release mechanisms configured to secure the rollout table in the extended position;
wherein the one or more lock-and-release mechanisms include breakaway detents, and when the rollout table is held in the extended position by the one or more lock-and-release mechanisms, the rollout table articulates into the retracted position in response to the breakaway detents being subjected to an externally applied force exceeding a predetermined threshold force;
the rollout table floats over the first and second arms and a lip lining the opening of the housing; and
one of the plurality of slats proximate the free end of the rollout table is wider than one of the plurality of slats proximate the secured end of the rollout table.

According to a second aspect of the present disclosure, a deployable table assembly has a housing installed in a vehicle, where the housing has an opening. A rollout table with a free end and an opposing secured end is rotatably coupled to the housing, and the rollout table is configured to articulate between an extended position and a retracted position along a deployment axis. The deployable table assembly also has a support mechanism having a first arm with a first end connected to the rollout table near the free end and a second end connected to the housing. In the retracted position, the rollout table is substantially rolled up within the housing and not substantially protruded from the housing. In the extended position, the rollout table is at least partially unrolled from within the housing and at least partially protruded from the housing. Furthermore, the rollout table is configured to pass through the opening of the housing when articulating into the extended position from the retracted position or into the retracted position from the extended position. One of the first and second ends of the first arm of the support mechanism is pivotably connected to the rollout table or the housing, and one of the first and second ends of the first arm of the support mechanism is slidably connected to the rollout table or the housing.

Embodiments of the second aspect of the present disclosure can include any one or a combination of the following features:
the first arm is pivotably connected to a second arm having a first end connected to the rollout table near the free end and a second end connected to the housing, one of the first and second ends of the second arm is pivotably connected to the rollout table or the housing, and one of the first and second ends of the second arm is slidably connected to the rollout table or the housing;
a lip running along the opening, the second end of the first arm and the second end of the second arm are coupled to the lip, and the rollout table floats over the lip and the first and second arms when the rollout table articulates between the extended position and the retracted position;
one of the first and second ends of the first arm is disposed within a first slot defined in the rollout table or the housing, one of the first and second ends of the second arm is disposed within a second slot defined in the rollout table or the housing, and at least one of the first and second slots has one or more lock-and-release mechanisms configured to secure the rollout table at a plurality of extended positions along the deployment axis;
the one or more lock-and-release mechanisms include one or more breakaway detents configured to prevent the rollout table from articulating into the retracted position unless an external force exceeding a threshold force is applied to the one or more breakaway detents; and
the rollout table comprises a plurality of slats running perpendicular to the deployment axis, and one of the plurality of slats proximate the free end of the
rollout table is wider than one of the plurality of slats proximate the secured end of the rollout table.

According to a third aspect of the present disclosure, a table for a vehicle interior, has a housing configured to be installed in a vehicle interior, where the housing includes an opening, a reel rotatably coupled to the housing, and a lip running along the opening of the housing. A rollout table has a secured end and an opposing free end, where the secured end is secured to the reel within the housing. The table for a vehicle interior also has a scissor joint assembly situated below the rollout table, where a first side of the scissor joint assembly is operably coupled to the lip of the housing and a second side of the scissor joint assembly is operably coupled to the rollout table proximate the free end. In the retracted position, the rollout table is configured to roll up onto the reel within the housing. In the extended position, the rollout table is configured extend out of the opening of the housing along a deployment axis.

Embodiments of the third aspect of the present disclosure can include any one or a combination of the following features:
the first side of the scissor joint assembly has a first end and a second end that are operably coupled to the lip of the housing by one of a pin joint and a slot joint, the second side of the scissor joint assembly has a first end and a second end that are operably coupled to the rollout table proximate the free end by one of a slot joint and a pin joint, and the scissor joint assembly is coupled to the lip of the housing and the rollout table proximate the free end by two pin joints and two slot joints;
the rollout table further comprises a plurality of slats running perpendicular to the deployment axis, the slats are configured to enable the rollout table to roll up around the reel, and one of the plurality of slats proximate the free end of the rollout table is wider than one of the plurality of slats proximate the secured end of the rollout table;
the two slot joints of the scissor joint assembly include one or more lock-and-release mechanisms configured to secure the rollout table in a plurality of extended positions along the deployment axis; and
the one or more lock-and-release mechanisms of the two slot joints include one or more breakaway detents, and when the rollout table is secured in one of the plurality of extended positions by the one or more lock-and-release mechanisms, the table articulates into the retracted position in response to an external force exceeding a threshold force being applied to the breakaway detents.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a vehicle having a rollout table assembly shown deployed according to one example;

FIG. 2 is an exploded view of the rollout table assembly according to one embodiment;

FIG. 3A is a perspective view of the rollout table assembly in FIG. 2 in a retracted position;

FIG. 3B is a perspective view of the rollout table assembly in FIG. 2 in an extended position;

FIG. 4 is an upper perspective view of the rollout table assembly in FIG. 3B in a partially extended position and having two scissor joint support assemblies;

FIG. 5 is a cross-sectional view of the rollout table assembly taken along line V-V of FIG. 3B;

FIG. 6A is a perspective view of another embodiment of the rollout table assembly including a pair of support arms in a first partially extended position;

FIG. 6B is a perspective view of the rollout table assembly in FIG. 6A including a pair of support arms in a second partially extended position;

FIG. 7A is a perspective view of a first series of pivotal connections of a plurality of slats of the rollout table;

FIG. 7B is a partial exploded view of a pivotal connection of the first series of pivotal connections of two of the plurality of slats of the rollout table;

FIG. 8A is a perspective view of a second series of pivotal connections of the plurality of slats of the rollout table; and

FIG. 8B is a partial exploded view of a pivotal connection of the second series of pivotal connections of two of the plurality of slats of the rollout table.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show a function overview. Therefore, specific structural and functional details disclosed herein are not to be interpreted as limiting, but merely as a representative basis for teaching one skilled in the art to variously employ the present disclosure.

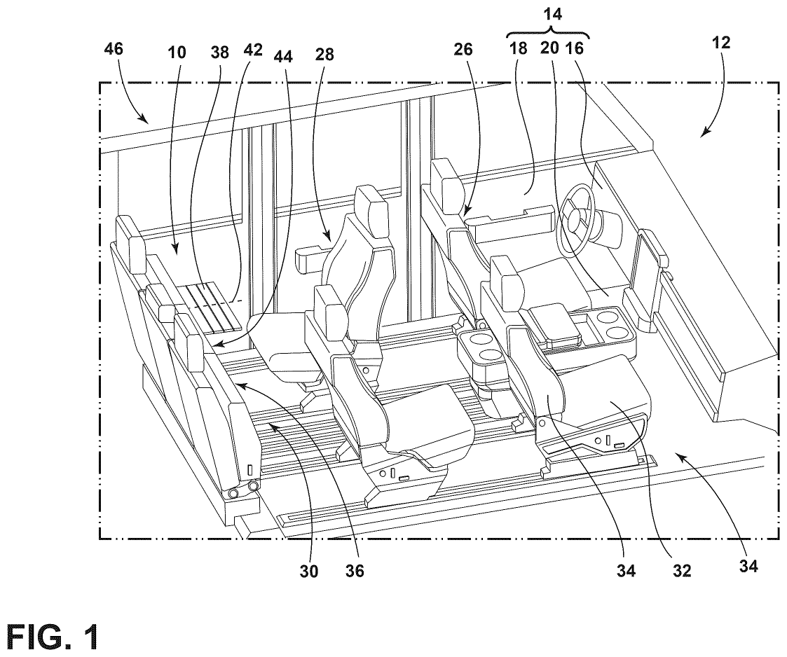

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a rollout table assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

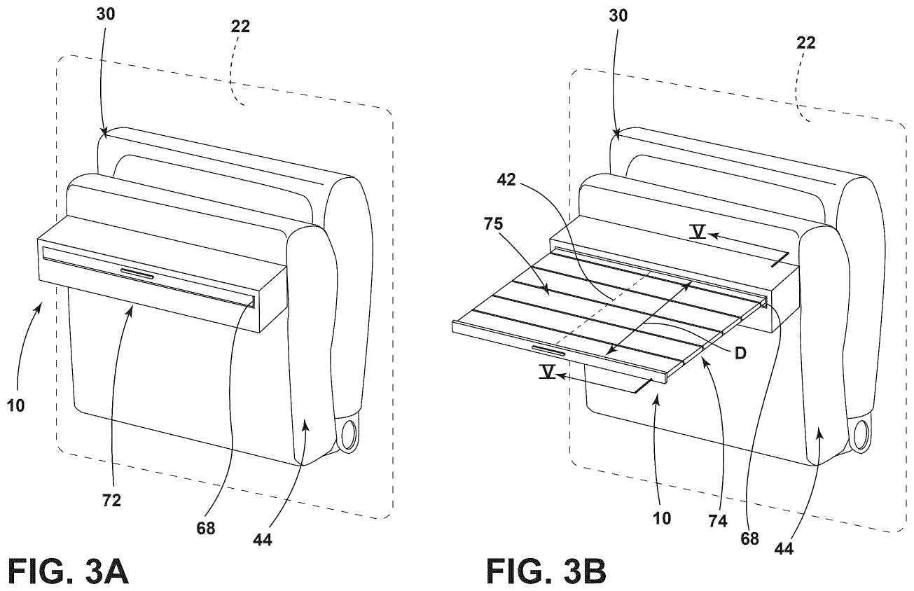

With initial reference to FIG. 1, reference numeral 10 generally designates a rollout table assembly. The rollout table assembly 10 is configured to be installed in a vehicle 12, such as a wheeled motor vehicle, an aircraft, or a watercraft. The vehicle 12 shown in FIG. 1 has a plurality of panels 14, including a front panel 16, a side panel 18, a bottom panel 20, and a rear panel 22 (FIGS. 3A and 3B), the plurality of panels 14 defining a vehicle interior 24 including a first seating assembly 26 situated proximate the front panel 16 and facing the front panel 16, the front panel 16 being a dashboard. A second seating assembly 28 is situated in a vehicle rearward direction relative to the first seating assembly 26 and facing the front panel 16, and a third seating assembly 30 is situated in a vehicle rearward direction relative to the second seating assembly 28 and facing the front panel 16. Each of the seating assemblies includes a seat base 32 and a seat back 34. Each seat back 34 may be pivotable relative to the seat base 32. Each seat base 32 may be translatable in a forward and/or a rearward direction with respect to the vehicle 12 and may be horizontally pivotable to face the side panel 18 or the rear panel 22. Further, the seat base 32 of the third seating assembly 30 may be pivotable between a use position and a folded position 36, wherein the seat base 32 of the third seating assembly 30 is positioned in a horizontal orientation in the use position and the seat base 32 of the third seating assembly 30 is positioned in a vertical orientation in the folded position.

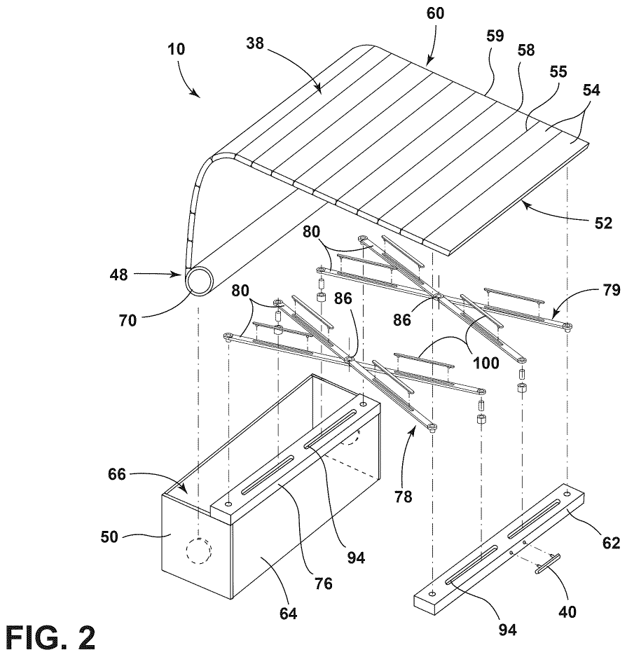

The rollout table assembly 10 in FIG. 1 is shown in one example disposed on the seat base 32 of the third seating assembly 30 and is accessible for use by a passenger when the seat base 32 of the third seating assembly 30 is in the folded position 36. Accordingly, when the seat base 32 of the third seating assembly 30 is in the folded position 36 and the second seating assembly 28 is pivoted to face the third seating assembly 30, the rollout table assembly is accessible to a passenger in the second seating assembly 28. It should be appreciated that one or more seating assemblies such as the second seating assembly 28 may be rotated to face vehicle rearward as shown when the vehicle is parked and inoperable. A passenger can extend a rollout table 38 from the rollout table assembly 10 by pulling a handle 40 (FIG. 2) of the rollout table 38 along a deployment axis 42 and thereafter use the rollout table 38 as a work surface, shelf, storage mechanism, etc. In alternative embodiments, an installment location 44 of the rollout table assembly 10 may be disposed on or within one of the plurality of panels 14 including the front panel 16, the side panel 18, the bottom panel 20, and the rear panel 22. Further, the rollout table assembly 10 may be disposed on or within the seat base 32 of another seating assembly, or on or within the seat back 34 of one of the seating assemblies. It is also contemplated that the rollout table assembly 10 may be provided on or within one of the plurality of panels 14 on an exterior 46 of the vehicle 12.

With reference to FIG. 2, the rollout table 38 of the rollout table assembly 10 includes a secured end 48 rotatably coupled to a housing 50, a free end 52, and a plurality of slats 54 running perpendicular to the deployment axis 42. Generally, in one example, the plurality of slats 54 are uniform in length and width, forming a series of pivotal connections 55 with each other at one or more joints 58, wherein outer edges 59 of the slats 54 form side edges 60 of the rollout table 38. It is contemplated that the plurality of slats 54 may have varying dimensions. For example, the widths of the slats 54 proximate the free end 52 may be larger than the widths of the slats 54 proximate the secured end 48 to provide better support for the rollout table 38 and/or to enable a tighter stowage of the rollout table 38. Furthermore, the slats 54 of the rollout table 38 may be made of a metal material, such as steel, Aluminum, or Titanium, for example.

A crossbar 62 is disposed along the free end 52 of the rollout table 38 such that the crossbar 62 runs parallel to the plurality of slats 54, wherein the handle 40 is disposed on the crossbar 62. The free end 52 is configured to extend out from the housing 50 along the deployment axis 42 in response to a passenger pulling the handle 40 with force away from the housing 50 along the deployment axis 42. Furthermore, the free end 52 of the rollout table 38 is configured to retract into the housing 50 in response to a passenger pushing the handle 40 with force toward the housing 50 along the deployment axis 42. The rollout table assembly 10 may alternatively be equipped with a biasing mechanism configured to urge the rollout table 38 to retract into the housing 50 without the need for a passenger to push the handle 40 toward the housing 50. The crossbar 62 may also be made of a metal material such as steel, Aluminum, or Titanium.

The housing 50 of the rollout table assembly 10 may resemble an elongated box or tube, defining a front face 64 and an interior space 66. Furthermore, the front face 64 of the housing 50 defines an opening 68 configured to receive the rollout table 38. When the seat base 32 of the third seating assembly 30 is in the folded position 36, the front face 64 of the housing 50 protrudes horizontally from the seat base 32. In alternative embodiments, the rollout table assembly 10 may be disposed within the seat base 32 of the third seating assembly 30 such that the front face 64 of the housing 50 is flush with the seat base 32.

The secured end 48 of the rollout table 38 is connected to a reel 70 contained in the interior space 66 of the housing 50, wherein the connection between the rollout table 38 and the reel 70 may be fixed or pivotal. The reel 70 is rotatably coupled to the housing 50 and, consequently, the secured end 48 of the rollout table 38 is rotatably coupled to the housing 50. The plurality of slats 54 of the rollout table 38 are configured to articulate around the reel 70 and any slats 54 rolled up onto the reel 70. To create a tighter packing of slats 54 around the reel 70, the slats 54 proximate the secured end 48 of the rollout table 38 may be slimmer in thickness and/or width than the slats 54 proximate the free end 52 of the rollout table 38.

With reference to FIGS. 2, 3A, and 3B, the rollout table 38 is operable between a retracted position 72, shown in FIG. 3A, and an extended position 74, shown in FIG. 3B. In the retracted position 72, a substantial portion of the rollout table 38 is rolled up around the reel 70 in the interior space 66 of the housing 50, and the free end 52 of the rollout table 38 is substantially received by the opening 68 of the housing 50. When the rollout table 38 is in the retracted position 72, the seat base 32 of the third seating assembly 30 is operable between the folded position 36 and the use position without interference by the rollout table assembly 10. Additionally, the reel 70 of the housing 50 may further be equipped with a biasing mechanism, such as a biasing spring, configured to bias the rollout table 38 in the retracted position 72, which may help to prevent the rollout table 38 from extending from the housing 50 when the rollout table assembly 10 is not in use. Alternatively, the rollout table assembly 10 may not have a biasing spring such that the rollout table 38 is configured to hold its position unless acted on by an externally applied force.

In the extended position 74, the rollout table 38 is substantially unrolled off of the reel 70 and substantially extended through the opening 68 of the housing 50. The plurality of slats 54 of the rollout table 38 extending from the opening 68 are articulated to form a substantially flat surface 75. The substantially flat surface 75 may be formed as a result of device(s) such as a geometry of the plurality of slats 54 proximate the joints 58 of the rollout table 38, lock-and-release mechanisms integrated into the rollout table assembly 10, and/or supporting linkages underlying at least some of the plurality of slats 54 when the rollout table 38 is extended from the housing 50. Notably, the device(s) responsible for enabling the rollout table 38 to form the substantially flat surface 75 may be also be configured to provide the rollout table 38 with resistance against vertical displacement resulting from externally applied force when the rollout table 38 is in the extended position 74.

The rollout table 38 is generally shown in connection with the reel 70 of the housing 50 and the crossbar 62. The opening 68 of the housing 50 is lined with a lip 76, wherein the rollout table 38 is configured to float over or be in frictionless contact with the lip 76 when the rollout table 38 articulates from the retracted position 72 to the extended position 74. The lip 76 may protrude from the opening 68 of the housing 50 in a direction parallel and/or perpendicular to the deployment axis 42.

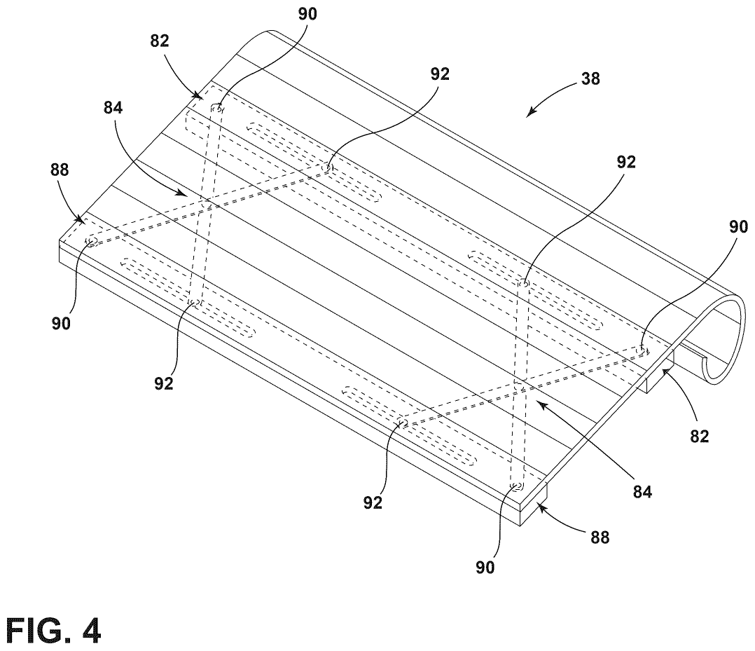

With reference to FIGS. 2 and 4, to assist the articulation of the rollout table 38 between the retracted position 72 and the extended position 74, and/or to support the rollout table 38, the rollout table assembly 10 further includes a support mechanism shown in one embodiment having two scissor joint assemblies 78, 79 secured below the plurality of slats 54 of the rollout table 38. Each of the pair of scissor joint assemblies 78, 79 have a pair of cross-connected arms 80. Additionally, each of the scissor joint assemblies 78, 79 has a first side 82 operably coupled to the lip 76 of the housing 50, an intermediate portion 84 including a scissor joint 86, and a second side 88 operably coupled to the crossbar 62, wherein the first and second sides 82, 88 of the scissor joint assemblies 78, 79 include one end of each of the pair of arms 80. The first side 82 of each of the scissor joint assemblies 78, 79 includes a pin-joint end 90 rotatably coupled to the lip 76 and a slot-joint end 92 slidably coupled to the lip 76 and disposed in a slot 94 defined by the lip 76. Similarly, the second side 88 of each of the scissor joint assemblies 78, 79 includes a pin-joint end 90 rotatably coupled to the crossbar 62 and a slot-joint end 92 slidably coupled to the crossbar 62 and disposed in a slot 94 defined by the crossbar 62. It is contemplated that the first side 82 of each of the scissor joint assemblies 78, 79 may alternatively include two pin-joint ends 90 rotatably coupled to the lip 76 or two slot-joint ends 92 slidably coupled to the lip 76, while the second side 88 of each of the scissor joint assemblies 78, 79 includes two slot-joint ends 92 slidably coupled to the crossbar 62 or two pin-joint ends 90 rotatably coupled to the crossbar 62, respectively. The slot joint connection between the slot-joint ends 92 and the slots 94 of the lip 76 and/or the crossbar 62 may comprise a bushing configured to slide or roll within the slot 94. Furthermore, the arms 80 of the scissor joint assemblies 78, 79 may be made of a metal material, such as steel, Aluminum, or Titanium, for example.

The pin-joint ends 90 of the first and second sides 82, 88 of the scissor joint assemblies 78, 79 are positioned closer to the side edges 60 of the rollout table 38 than the slot-joint ends 92. In alternative embodiments, the slot-joint ends 92 of the first and second sides 82, 88 of the scissor joint assemblies 78, 79 may be positioned closer to the side edges 60 of the rollout table 38 than the pin-joint ends 90 of the scissor joint assemblies 78, 79. The scissor joint assemblies 78, 79 may also be asymmetrical such that a pin-joint end 90 of the second side 88 of the first scissor joint assembly 78 is closer to one of the side edges 60 than a slot-joint end 92 of the second side 88 of the first scissor joint assembly 78, while a slot-joint end 92 of the second side 88 of the second scissor joint assembly 79 is closer to one of the side edges 60 than a pin-joint end 90 of the second side 88 of the second scissor joint assembly 79.

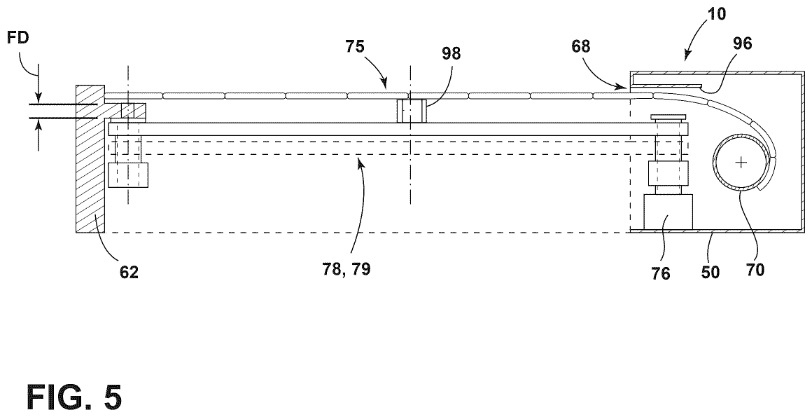

Referring now to FIG. 5, the rollout table 38 is shown connected to both the reel 70 in the interior space 66 of the housing 50 and the crossbar 62, the connections enabling the rollout table 38 to float above the lip 76 of the housing 50 and the pair of scissor joint assemblies 78, 79, providing for minimal or no contact between the lip 76 and the rollout table 38 and between the pair of scissor joint assemblies 78, 79 and the rollout table 38. Preferably, the rollout table 38 is spaced from the lip 76 of the housing 50 and the pair of scissor joint assemblies 78, 79 by a float distance FD which may, for example, range from zero millimeters to two millimeters. The rollout table 38 is further in minimal or no contact with a ceiling 96 within the opening 68 of the housing 50. In some embodiments, the scissor joints 86 of the pair of scissor joint assemblies 78, 79 may include a spacer 98 to maintain the float distance FD between the scissor joints 86 and the rollout table 38 and to minimize wear on the components of the rollout table assembly 10. The pair of arms 80 of each of the pair of scissor joint assemblies 78, 79 may also be covered with abrasion-resistant elements 100 (FIG. 2) made of a material such as felt or Teflon to minimize wear on the components of the rollout table assembly 10.

With further reference to FIGS. 2-4, the rollout table 38 is operable between the retracted position 72 and the extended position 74. In the retracted position 72, the rollout table 38 is substantially rolled up onto the reel 70 in the interior space 66 of the housing 50, and the crossbar 62 does not substantially protrude from the opening 68 of the housing 50. As a result, the crossbar 62 is proximate the lip 76 of the housing 50 in the retracted position 72. The pair of arms 80 of each of the pair of scissor joint assemblies 78, 79 pivot toward an orientation that is parallel to the crossbar 62 when the rollout table 38 is operated from the extended position 74 to the retracted position 72. By contrast, the rollout table 38 is substantially unrolled off of the reel 70 and substantially extends from the opening 68 of the housing 50 in the extended position 74. Accordingly, the lip 76 of the housing 50 and the crossbar 62 are separated by a distance D in the extended position 74, and the pair of arms 80 of each of the pair of scissor joint assemblies 78, 79 are pivoted toward an orientation that is parallel to the deployment axis 42 when the rollout table 38 is operated from the retracted position 72 to the extended position 74.

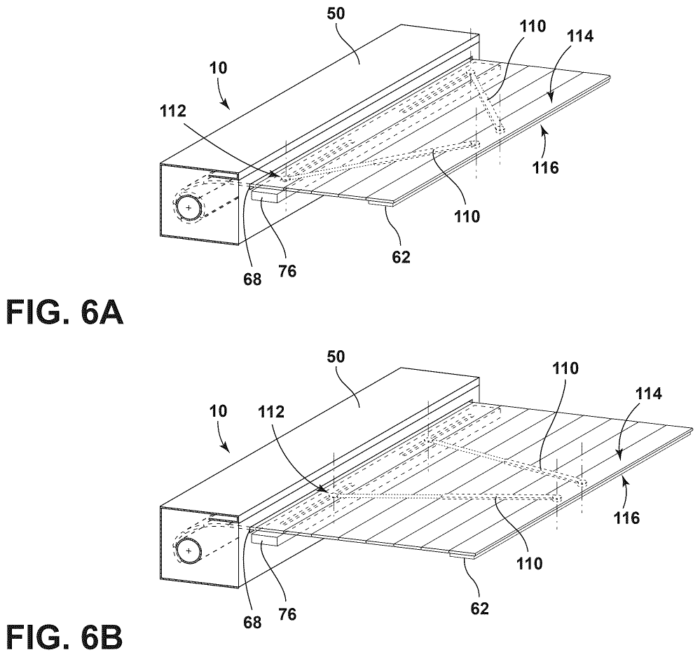

Instead of the pair of scissor joint assemblies 78, 79, the rollout table assembly 10 may be configured according to another embodiment as shown in FIGS. 6A and 6B, which utilizes a pair of separate support arms 110 that are each pivotally and slidably coupled to the rollout table assembly 10. Each support arm 110 has a first side 112 slidably coupled to the lip 76 of the housing 50 and a second side 114 pivotally coupled to the crossbar 62. Alternatively, the first sides 112 of each of the support arms 110 may be pivotally coupled to the lip 76 and the second sides 114 of each of the support arms 110 may be slidably coupled to the crossbar 62.

Similar to embodiments of the rollout table assembly 10 utilizing at least one of the scissor joint assemblies 78, 79, the support arms 110 may be covered with abrasion-resistant elements 100 (FIG. 2). Additionally, the pair of support arms 110 pivot toward an orientation that is parallel to the crossbar 62 when the rollout table 38 is operated from the extended position 74 to the retracted position 72, and the pair of support arms 110 are pivoted toward an orientation that is parallel to the deployment axis 42 when the rollout table 38 is operated from the retracted position 72 to the extended position 74. A single support arm system for the rollout table assembly 10 is also contemplated.

The rollout table 38 may be operated from the retracted position 72 to the extended position 74 or a partially extended position 116, as shown in FIGS. 6A and 6B. When the rollout table 38 is in the partially extended position 116, the rollout table 38 is at least partially unrolled off of the reel 70 and at least partially protruded from the opening 68 of the housing 50, the rollout table 38 being positioned in between the retracted position 72 and the extended position 74. Additionally, there may be more than one partially extended position 116, allowing a passenger to extend the rollout table 38 to multiple deployed table lengths.

With reference to all embodiments of the rollout table assembly 10, including those discussed herein, the rollout table assembly 10 may additionally include one or more lock-and-release mechanisms configured to secure the rollout table 38 in the extended position 74 and/or the partially extended position 116. The one or more lock-and-release mechanisms may be integrated into the rollout table 38 in several locations, including within the slots 94 of the rollout table assembly 10. For example, a lock-and-release mechanism may be a detent disposed within the slot 94 of the lip 76 and/or the crossbar 62, wherein the detent is configured to inhibit movement of one of the slot-joint ends 92 of one of the scissor joint assemblies 78, 79, thereby preventing the rollout table 38 from retracting unless intentionally operated to retract by a passenger. Furthermore, the detent may be configured to breakaway and allow the table to roll up into the retracted position 72 when the table is subjected to an externally applied force exceeding a threshold force.

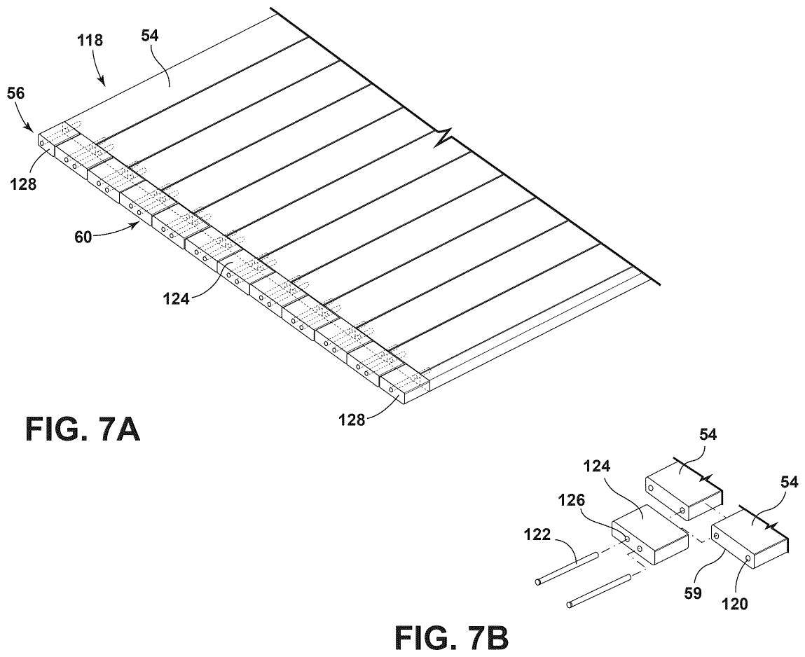

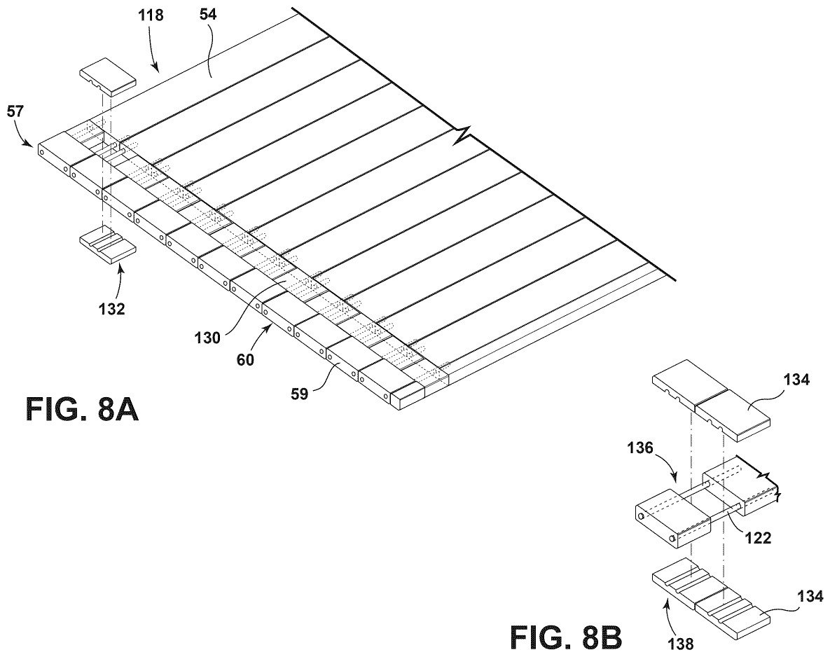

FIGS. 7A, 7B, 8A, and 8B show example embodiments of the series of pivotal connections 55 of the plurality of slats 54 of the rollout table 38. In FIG. 7A, a side portion 118 of the rollout table 38 is shown having a first series of pivotal connections 56. Each of the plurality of slats 54 defines two apertures 120 (FIG. 7B) at the outer edge 59, wherein each aperture 120 is configured to receive one pin 122. The rollout table assembly 10 further includes a plurality of end caps 124, wherein the plurality of end caps 124 define the side edge 60 of the rollout table 38. Each of the plurality of end caps 124 also defines two apertures 126, each aperture 126 being configured to receive one pin 122, wherein each of the plurality of end caps 124 receives two pins 122 received by two of the plurality of slats 54. Accordingly, each of the plurality of end caps 124 overlaps two of the plurality of slats 54, creating a pivotal connection therein between. The free end 52 of the rollout table 38 and the secured end 48 of the rollout table 38 may each have unique end caps 128 configured to receive one pin 122 received by one of the plurality of slats 54 and may only overlap one of the plurality of slats 54.

In FIG. 8A, a side portion 118 of the rollout table 38 is shown having a second series of pivotal connections 57. The rollout table 38 includes the plurality of slats 54, wherein each of the plurality of slats 54 has two pins 122 (FIG. 8B) exposed in a gap 130 in the slat 54 proximate the outer edge 59. The gaps 130 of the plurality of slats 54 are aligned parallel to the deployment axis 42 and are configured to receive links 132. The links 132 have two halves 134 that clamp onto two pins 122 of two different slats 54, wherein one of the two halves 134 straddles said pins 122 from a top 136 of the rollout table 38 and one of the two halves 134 straddles said pins 122 from a bottom 138 of the rollout table 38. Each pin 122 received by each link 132 is rotatably coupled to the link 132, thereby allowing the rollout table 38 to articulate around the reel 70 and into the substantially flat surface 75.

Notably, the embodiments of the series of pivotal connections 55 of the plurality of slats 54 of the rollout table 38 shown in FIGS. 7A-8B are two examples and are intended to be nonlimiting. The plurality of slats 54 of the rollout table 38 may be alternatively connected. For example, the plurality of slats 54 may be pivotally interlocked with each other. Alternatively, the rollout table 38 may have a single, flexible surface made of a material configured to articulate between the extended position 74 and the retracted position 72.

The vehicle table assembly advantageously provides for a deployable rollout table for use in the vehicle and may be compactly stowed when not in use. The support mechanism of the deployable rollout table, which is configured to assist the articulation of the rollout table between deployment positions and/or to support the rollout table against externally applied loads, is also configured to prevent warping or yawing of the table.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicular table assembly, comprising:
a housing configured to be secured to a vehicle, the housing having an opening;
a rollout table coupled to the housing and operable between an extended position and a retracted position along a deployment axis, the rollout table having a plurality of slats running perpendicular to the deployment axis; and
a support mechanism having a first arm with a first end and a second end, wherein the first end is coupled to the rollout table and the second end is coupled to the housing;
wherein the rollout table is rolled up within the housing in the retracted position; and
wherein the rollout table is at least partially extended from the opening of the housing in the extended position.

2. The vehicular table assembly of claim 1, wherein the first arm has one pinned end and one unpinned end.

3. The vehicular table assembly of claim 2, further comprising a reel disposed in an interior space defined by the housing, the reel being rotatably coupled to the housing;
wherein the rollout table has a free end and an opposing secured end coupled to the reel within the housing;
wherein a crossbar is disposed along the free end of the rollout table; and
wherein the first end of the first arm is coupled to the crossbar.

4. The vehicular table assembly of claim 3, further comprising a second arm having a first end and a second end, wherein the first end of the second arm is coupled to the crossbar and the second end of the second arm is coupled to the housing, and wherein the second arm has one pinned end and one unpinned end.

5. The vehicular table assembly of claim 4, wherein one end of each of the first and second arms forms a pin joint connection with one of the housing and the crossbar; and
wherein one end of each of the first and second arms is slidably disposed within a slot defined by one of the housing and the crossbar.

6. The vehicular table assembly of claim 5, wherein the slot includes one or more lock-and-release mechanisms configured to secure the rollout table in an extended position.

7. The vehicular table assembly of claim 6, wherein the one or more lock-and-release mechanisms include breakaway detents; and
wherein, when the rollout table is held in the extended position by the one or more lock-and-release mechanisms, the rollout table articulates into the retracted position in response to the breakaway detents being subjected to an externally applied force exceeding a predetermined threshold force.

8. The vehicular table assembly of claim 1, wherein the rollout table floats over the first and second arms and a lip lining the opening of the housing.

9. The vehicular table assembly of claim 3, wherein one of the plurality of slats proximate the free end of the rollout table is wider than one of the plurality of slats proximate the secured end of the rollout table.

10. A deployable table assembly, comprising:
a housing configured to be installed in a vehicle, wherein the housing has an opening;
a rollout table having a free end and an opposing secured end rotatably coupled to the housing, wherein the rollout table is configured to articulate between an extended position and a retracted position along a deployment axis;
a support mechanism having a first arm with a first end connected to the rollout table near the free end and a second end connected to the housing;
wherein the rollout table is substantially rolled up within the housing and not substantially protruded from the housing in the retracted position;
wherein the rollout table is at least partially unrolled from within the housing and at least partially protruded from the housing in the extended position;
wherein the rollout table is configured to pass through the opening of the housing when articulating into the extended position from the retracted position or into the retracted position from the extended position;
wherein one of the first and second ends of the first arm of the support mechanism is pivotably connected to the rollout table or the housing; and
wherein one of the first and second ends of the first arm of the support mechanism is slidably connected to the rollout table or the housing.

11. The deployable table assembly of claim 10, wherein the first arm is pivotably connected to a second arm having a first end connected to the rollout table near the free end and a second end connected to the housing;
wherein one of the first and second ends of the second arm is pivotably connected to the rollout table or the housing; and
wherein one of the first and second ends of the second arm is slidably connected to the rollout table or the housing.

12. The deployable table assembly of claim 11, further comprising a lip running along the opening, wherein the second end of the first arm and the second end of the second arm are coupled to the lip, and further wherein the rollout table floats over the lip and the first and second arms when the rollout table articulates between the extended position and the retracted position.

13. The deployable table assembly of claim 11, wherein one of the first and second ends of the first arm is disposed within a first slot defined in the rollout table or the housing;
wherein one of the first and second ends of the second arm is disposed within a second slot defined in the rollout table or the housing; and
wherein at least one of the first and second slots has one or more lock-and-release mechanisms configured to secure the rollout table at a plurality of extended positions along the deployment axis.

14. The deployable table assembly of claim 13, wherein the one or more lock-and-release mechanisms include one or more breakaway detents configured to prevent the rollout table from articulating into the retracted position unless an external force exceeding a threshold force is applied to the one or more breakaway detents.

15. The deployable table assembly of claim 10, wherein the rollout table comprises a plurality of slats running perpendicular to the deployment axis, and further wherein one of the plurality of slats proximate the free end of the rollout table is wider than one of the plurality of slats proximate the secured end of the rollout table.

16. A table for a vehicle interior, comprising:
a housing configured to be installed in a vehicle interior, the housing including an opening, a reel rotatably coupled to the housing, and a lip running along the opening of the housing;
a rollout table having a secured end and an opposing free end, wherein the secured end is secured to the reel within the housing;
a scissor joint assembly situated below the rollout table, wherein a first side of the scissor joint assembly is operably coupled to the lip of the housing and a second side of the scissor joint assembly is operably coupled to the rollout table proximate the free end;
wherein the rollout table is configured to roll up onto the reel within the housing in a retracted position; and
wherein the rollout table is configured extend out of the opening of the housing along a deployment axis in an extended position.

17. The table for a vehicle interior of claim 16, wherein the first side of the scissor joint assembly has a first end and a second end that are operably coupled to the lip of the housing by one of a pin joint and a slot joint;
wherein the second side of the scissor joint assembly has a first end and a second end that are operably coupled to the rollout table proximate the free end by one of a slot joint and a pin joint; and
wherein the scissor joint assembly is coupled to the lip of the housing and the rollout table proximate the free end by two pin joints and two slot joints.

18. The table for a vehicle interior of claim 17, wherein the rollout table further comprises a plurality of slats running perpendicular to the deployment axis, wherein the slats are configured to enable the rollout table to roll up around the reel; and
wherein one of the plurality of slats proximate the free end of the rollout table is wider than one of the plurality of slats proximate the secured end of the rollout table.

19. The table for a vehicle interior of claim 18, wherein the two slot joints of the scissor joint assembly include one or more lock-and-release mechanisms configured to secure the rollout table in a plurality of extended positions along the deployment axis.

20. The table for a vehicle interior of claim 19, wherein the one or more lock-and-release mechanisms of the two slot joints include one or more breakaway detents; and
wherein, when the rollout table is secured in one of the plurality of extended positions by the one or more lock-and-release mechanisms, the table articulates into the retracted position in response to an external force exceeding a threshold force being applied to the breakaway detents.
